(19) United States
(12) Patent Application Publication
(10) Pub. No.: US 2019/0204443 A1
(43) Pub. Date: Jul. 4, 2019

(54) OPTICAL RANGING METHOD, PHASE DIFFERENCE OF LIGHT MEASUREMENT SYSTEM AND OPTICAL RANGING LIGHT SOURCE

(71) Applicant: INDUSTRIAL TECHNOLOGY RESEARCH INSTITUTE, Hsinchu (TW)

(72) Inventors: Bin-Cheng YAO, Taipei City (TW); Jin-Long PENG, Hsinchu City (TW)

(73) Assignee: INDUSTRIAL TECHNOLOGY RESEARCH INSTITUTE, Hsinchu (TW)

(21) Appl. No.: 15/857,216

(22) Filed: Dec. 28, 2017

(51) Int. Cl. G01S 17/48; G02B 27/10; G01S 7/481; G01S 7/484

(52) U.S. Cl. CPC G01S 17/48; G02B 27/1006; G01S 7/484; G01S 7/4815; G02B 27/1086

(57) ABSTRACT

A ranging light source includes a light source, a frequency division device and a transmitter. The light source is configured to generate a comb laser. The frequency division device is configured to generate a plurality of emitting n laser beams. These emitting laser beams have different center frequencies respectively. The transmitter is configured to output the emitting laser beams. The light source, the frequency division device and the transmitter are located on a first optical path. On the optical path, the frequency division device is between the light source and the transmitter.

### TECHNICAL FIELD

This invention is related to an optical ranging method, an optical phase difference detection system and a ranging light source thereof.

### BACKGROUND

As technology advancing, new products and applications are continuously brought out for benefiting humankind. Ranging is a key technology for implementing automation in semi-conductor testing or in developing unmanned systems. For example, self-driving cars can save related manpower and prevent people from driving tired, thus hold the eyes in recent years. As the velocity control on an unmanned car relating to the distances between the car and pedestrians, an unmanned system is very sensitive to position information. As a result, ranging is one of the important techniques to the unmanned systems as mentioned.

Ranging systems are usually categorized into laser ranging, sonar ranging and image ranging. These different ranging methods utilize different types of signals with different transmission times to obtain the transmission distance. The velocity of sound waves is about 315 meter per second. Therefore, it requires 0.1 seconds for sonar ranging to estimate a distance over 15 meters. The required ranging time is too long for some mobile applications, not to mention that sound waves are highly sensitive to environment interferences. The transmission velocity of a laser is 3×10⁸ meters per second which is slightly faster than operation speeds of most of the electronic devices, inducing difficulties in high resolution ranging. Performing ranging with the interference of lasers may obtain high resolution through wavelength difference but is complicated in long-distance ranging for period repetition computation.

In such a situation, a common and conventional optical phase difference detection system may have quite a large volume for realizing accurate control and is hard to do multi-point scanning quickly. For instance, a dual comb laser ranging system needs to use double laser sources. Though a comb laser source can have a narrowed downsize by utilizing a micro resonance chamber, the pulse repetition rate of an impulse laser thereof is about hundreds gigahertz, requiring high operation speed electronic components for implementation and resulting in high costs.

### SUMMARY

This invention provides an optical ranging method, an optical phase difference detection system and a ranging light source thereof, so as to realize accurate optical ranging, reducing equipment size and avoiding stray light effect with a high speed electrical component.

This invention discloses an optical ranging method, including: generating a comb laser; generating a plurality of emitting laser beams according to the comb laser, wherein the emitting laser beams are corresponding to different central frequencies respectively; generating a plurality of emitting laser beams according to the comb laser, wherein the emitting laser beams are corresponding to different central frequencies respectively; generating a plurality of emitting laser beams according to the comb laser, wherein the emitting laser beams are corresponding to different central frequencies respectively; outputting the emitting laser beams to different locations of a device under test to generate a plurality of reflected laser beams; generating a plurality of to-be-examined laser beams according to the reflected laser beams, wherein the central frequencies of the to-be-examined laser beams are different from each other; determining a plurality of first phase differences, wherein one of the first phase differences is a difference between a reference light and a respective one of the to-be-examined laser beams; determining a distance between a reference point and the device under test according to the first phase differences.

This invention discloses an optical phase difference detection system, comprising: a light source, a first frequency dividing device, a transmitter, a receiver and a first phase detector. The light source is configured to generate a comb laser. The first frequency dividing device is configured to generate a plurality of emitting laser beams, wherein the emitting laser beams have different central frequencies respectively. The transmitter is configured to output the emitting laser beam to different locations of a device under test to form a plurality of reflected laser beams. The receiver configured to receive the reflected laser beams. The first phase detector configured to determine a plurality of first phase differences, wherein one of the first phase differences is a difference between a reference light and a respective one of a plurality of to-be-examined laser beams formed according to the reflected laser beams. The light source, the frequency dividing device and the transmitter are disposed on the first optical path while the receiver and the first phase detector are on a second optical path, with the frequency dividing device disposed between the light source and the transmitter on the first optical path.

This invention discloses a ranging light source, comprising a light source, a frequency dividing device and a transmitter. The light source is configured to generate a comb laser. The frequency dividing device is configured to generate a plurality of emitting laser beams according to the comb laser, wherein the emitting laser beams have different center frequencies respectively. The transmitter configured to output the emitting laser beams. The light source, the frequency dividing device and the transmitter are disposed on a first optical path, and the frequency dividing device is between the light source and the transmitter on the first optical path.

The above description of the summary of this disclosure and the description of the following embodiments are provided to illustrate and explain the spirit and principles of this disclosure and to provide further explanation of the scope of this disclosure.

### BRIEF DESCRIPTION OF THE DRAWINGS

FIG. 1 is a flowchart of an optical ranging method in one embodiment of this invention.

FIG. 2 is a block diagram of an optical phase difference detection system in one embodiment of this invention.

FIG. 3 is an optical spectrum diagram of a comb laser and emitting laser beams in one embodiment of this invention.

FIG. 4 is a system structure diagram of an optical phase difference detection system in one embodiment of this invention.

FIG. 5 is a system structure diagram of an optical phase detection system in another embodiment of this invention.

### DETAILED DESCRIPTION

The detailed features and advantages of the disclosure will be described in detail in the following description, which is intended to enable any person having ordinary skill in the art to understand the technical aspects of the present disclosure and to practice it. In accordance with the teachings, claims and the drawings of the disclosure, any person having ordinary skill in the art is able to understand the objectives and advantages of the disclosure readily. The following embodiments illustrate the disclosure in further detail, but the scope of the disclosure is not limited by any point of view.

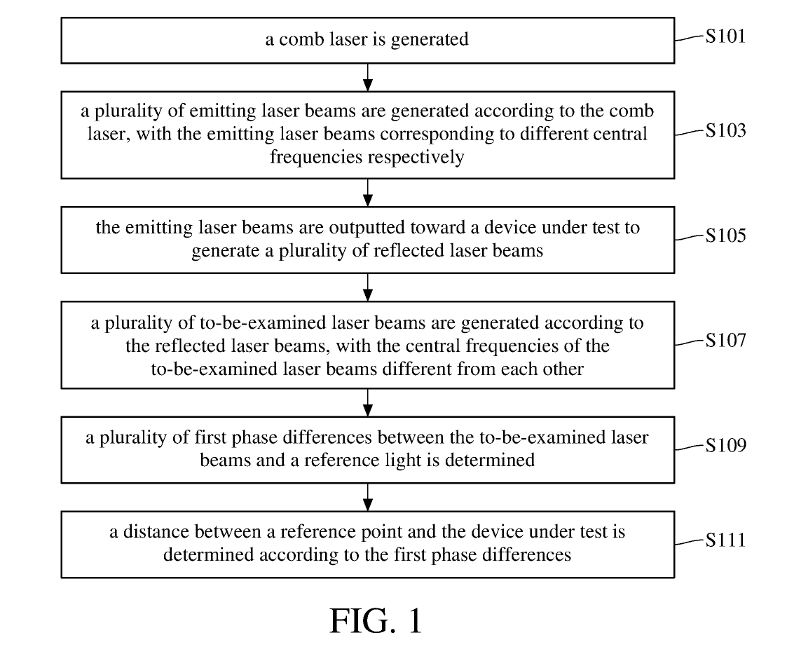

Please refer to FIG. 1, wherein FIG. 1 is a flowchart of an optical ranging method in one embodiment of this invention. In the step S101, a comb laser is generated; in the step S103, a plurality of emitting laser beams are generated according to the comb laser, with the emitting laser beams corresponding to different central frequencies respectively; in the step S105, the emitting laser beams are outputted toward a device under test to generate a plurality of reflected laser beams; in the step S107, a plurality of to-be-examined laser beams are generated according to the reflected laser beams, with the central frequencies of the to-be-examined laser beams different from each other; in the step S109, a plurality of first phase differences between the to-be-examined laser beams and a reference light is determined; in the step S111, a distance between a reference point and the device under test is determined according to the first phase differences.

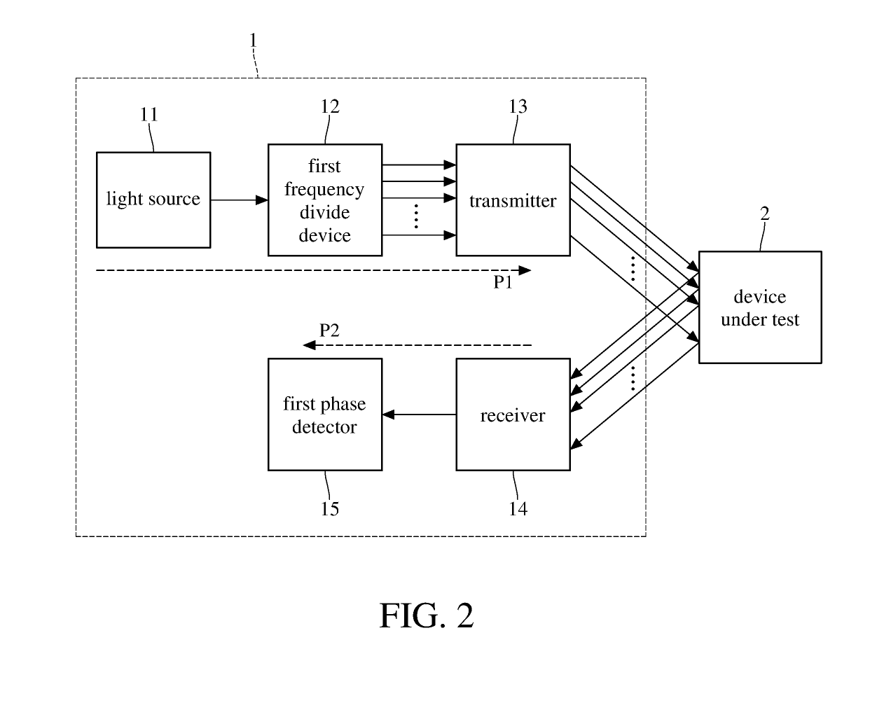

Please refer to FIG. 2 for a further description of the optical ranging method and a corresponding optical phase difference detection system. FIG. 2 is a block diagram of an optical phase difference detection system in one embodiment of this invention. As shown in FIG. 2, the optical phase difference detection system 1 includes a light source 11, a first frequency dividing device 12, a transmitter 13, a receiver 14 and a first phase detector 15. The light source 11, the first frequency dividing device 12 and the transmitter 13 are on a first optical path P1. On the first optical path P1, the first frequency dividing device 12 locates between the optical source 11 and the transmitter 13. The receiver 14 and the first phase detector 15 are on a second optical path P2.

The light source 11 is configured to generate a comb laser. Said comb laser is a pulse laser. In one embodiment, a center wavelength of the comb laser is about 1550 nanometer (nm). The max frequency bandwidth is related to the pulse width. The narrower the pulse width is, the wider the frequency bandwidth is.

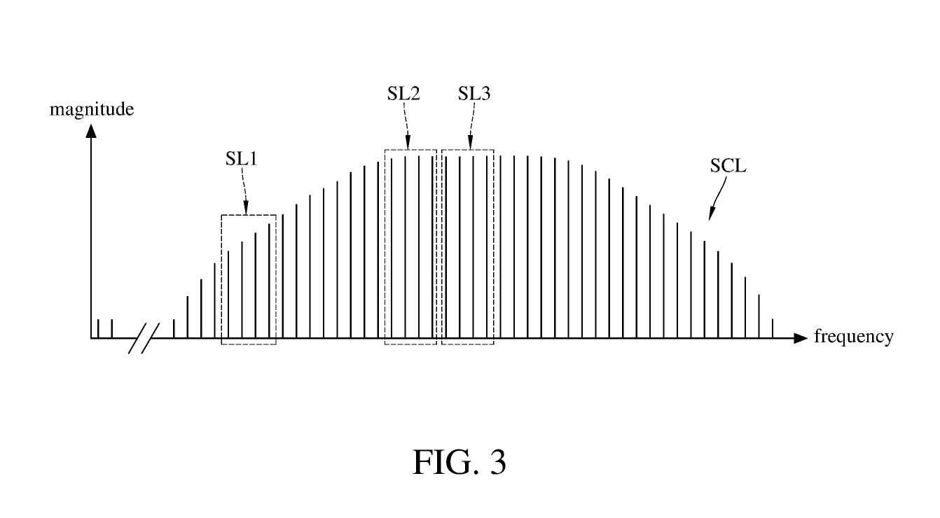

The first frequency dividing device 12 is configured to generate a plurality of emitting laser beams according to said comb laser. The emitting laser beams have different center frequencies respectively. Please refer to FIG. 3 for further illustration. FIG. 3 is an optical spectrum diagram of a comb laser and emitting laser beams according to one embodiment of this invention. As shown in the figure, the comb laser includes an optical spectrum SCL in the shape of a comb. The frequency intervals between and the magnitudes of the frequency components of the optical spectrum SCL are not limited herein. The optical spectrum SCL can be further defined with sub-bands SL1, SL2, SL3. . . . The first frequency dividing device 12 generates said emitting laser beams according to the sub-bands SL1, SL2, SL3 . . . respectively. In another aspect, there may be a first beam, a second beam and a third beam defined in the emitting laser beams, wherein the first beam is generated according to frequency components in the sub-band SL1, the second beam is generated according to frequency components in the sub-band SL2 and the third beam is generated according to frequency components in the sub-band SL3. Sub-bands SL1, SL2, SL3 are exemplified in FIG. 3, with the bandwidths of the sub-bands SL1, SL2, SL3 are different from each other. However, the number and the bandwidths of the sub-bands or the frequency intervals between neighbored sub-bands can be defined by a person having ordinary skill in the art with this invention and are not limited herein.

The transmitter 13 is configured to output said emitting laser beams to a device under test 2 to generate a plurality of reflected laser beams. The receiver 14 is configured to receive said reflected laser beams. The first phase detector 15 is configured to determine a plurality of first phase differences between a reference light and a plurality of to-be-examined laser beams formed by said reflected laser beams. A distance between the device under test 2 and a reference point can be detected according to a plurality of first phase differences provided by the first phase detector 15. Said reference point is, for example, a light output end of the transmitter 13 or an equivalent location where the optical phase difference detection system 1 locates, but is not limited thereto.

Based on the above structure, the optical phase difference detection system 1 generates a plurality of laser beams via a comb laser with fibers or non-linear optical components. High speed electronic components or active electronic components are not acquired in the generation of the laser beams, so that the cost and the power consumption of the optical phase difference detection system 1 are reduced. Besides, high resolution distance detection can be achieved by devices at the back end of the system with the provided laser beams. Different embodiments of the optical phase difference detection system are exemplified in the following. In another aspect, a ranging light source is also provided in this invention. The ranging light source at least includes said light source 11, said first frequency dividing device 12 and said transmitter 13. The structure of the ranging light source is not limited to the above, and please refer the following description of the optical phase difference detection system for related details thereof.

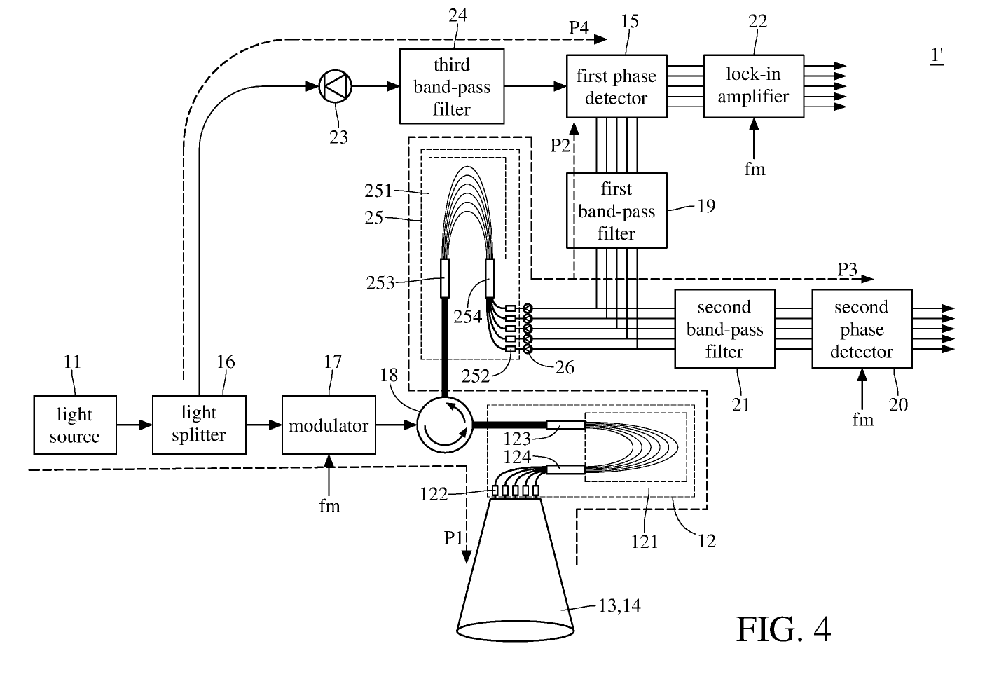

Please refer to FIG. 4 illustrating one implementation of the optical phase difference detection system. FIG. 4 is a system structure diagram of an optical phase difference detection system in one embodiment of this invention. In the embodiment of FIG. 4, optical phase difference detection system 1′ includes a light source 11, an optical splitter 16, a modulator 17, an optical circulator 18, a first frequency dividing device 12, an optical interface TRX, a first band-pass filter 19, a second band-pass filter 21, a first phase detector 15, a second phase detector 20, a lock-in amplifier 22, a light detector 23, a third band-pass filter 24, a second frequency dividing device 25 and a diffusion component 26.

As mentioned previously, the light source 11 is configured to generate a comb laser. The comb laser is provided to a first optical path P1 and the fourth optical path P4 through the splitter 16, wherein optical spectrums of a comb laser on the first optical path P1 and a comb laser on the fourth optical path P4 are substantially the same. In one embodiment, the energy of the comb laser on the first optical path P1 and the energy of the comb laser on the fourth optical path P4 are less than that of the comb laser before transmitted into the splitter 16.

On the first optical path P1, the modulator 17 is configured to adjust a pulse repetition rate of the comb laser. According to one embodiment, the comb laser has a first pulse repetition rate fr, and the modulator 17 is configured to selectively modulate the comb laser to have a second pulse repetition rate fm. In practice, the modulator 17 can be configured to selectively modulate the comb laser according to a user's instruction. The modulator 17 provides an additional modulation to start a lock-in amplifier and to improve distance uncertainties when the modulator 17 does not adjust the pulse repetition rate of the comb laser.

The modulated comb laser or the un-modulated comb laser is provided to the optical circulator 18. The optical circulator 18 has a first circulating optical path and a second circulating optical path which are not overlapped with each other. The optical circulator 18 provides the comb laser received from the modulator 17 for the first frequency dividing device 12 along the first circulating optical path. In this embodiment, the first frequency dividing device 12 includes a frequency divider 121, a plurality of collectors 122 and waveguide gratings 123, 124. A first end of the frequency divider 121 is coupled to the optical circulator 18 through the waveguide grating 123. A plurality of second ends of the frequency divider 121 are coupled to the collectors 122 through the waveguide grating 124. The comb laser is divided into a plurality of laser beams when the comb laser passes the frequency divider 121, with the laser beams having different center frequencies respectively. In practice, the number of the laser beams is related to the structure of the frequency divider 121 and thus is not limited to this invention. The collectors 122 receive the laser beams to generate said emitting comb laser respectively. In one embodiment, the collectors 122 receive the scattered laser beams based on a plurality of collection bands, with these collection bands corresponding to different center frequencies. In practice, the center frequency of each collector 122 is essentially equal to the center frequency of a corresponding one of the diffracted comb lasers. In other words, one of the collectors 122 is configured to generate a corresponding one of said emitting laser beams according to the laser beams. In one embodiment, the frequency divider 121 is, for example, an arrayed wave guide grating (AWG).

The optical interface TRX is configured to output said emitting laser beams to the device under test 2 to generate a plurality of reflected laser beams. In this embodiment, the optical interface TRX is further configured to receive the reflected laser beams generated by reflection of the emitting laser beams from the device under test 2. In practice, the optical interface TRX may include a plurality of output units and a plurality of input units, with each output unit configured to output a corresponding one of the emitting laser beams, and with each input unit configured to receive the reflected laser beams, so that the optical interface TRX includes said transmitter 13 and said receiver 14. The practical implementation of the optical interface TRX is not limited to this invention.

The optical interface TRX provides the reflected laser beams to the first frequency dividing device 12 when the optical interface TRX receives the reflected beams. The reflected laser beams are gathered by the first frequency divider 121 to form a gathered laser since the reflected laser beams enter from the second ends of the first frequency divider 121 and leave via the first end of the first frequency divider 121. The optical circulator 18 provides the gathered laser to the components at the back end along a second circulating optical path for processing.

In this embodiment, the gathered laser is provided to the second frequency dividing device 25. The second frequency dividing device 25 includes a second frequency divider 251, a plurality of collectors 252 and waveguides 253, 254. The structure of the second frequency dividing device 25 is similar to the structure of the first frequency dividing device 12, and the corresponding details are not repeated. Briefly, the second frequency dividing device 25 generates a plurality of to-be-examined laser beams according to the gathered laser. The to-be-examined laser beams are provided to the second optical path P2 and the third optical path P3. The components 26 are light detectors.

On the second optical path P2, the to-be-examined laser beams pass the first band-pass filter 19 at first. The center frequency of the first band-pass filter 19 is related to the first pulse repetition rate fr. On the third optical path P3, the to-be-examined laser beams pass the second band-pass filter 21 at first. The center frequency of the second band-pass filter 21 is related to the second pulse repetition rate fm.

The first phase detector 15 is configured to determine a plurality of phase differences between a reference light and the to-be-examined laser beams. Specifically, it is defined that the to-be-examined laser beams have a first to-be-examined laser beam, a second to-be-examined laser beam and a third to-be-examined laser beam. The first phase detector 15 is configured to determine a first phase difference between the reference light and the first to-be-examined laser beam, a second phase difference between the reference light and the second to-be-examined laser beam, and a third phase difference between the reference light and the third to-be-examined laser beam. The way that the first phase detector 15 determines the phase difference is not limited. In practical, the first phase detector 15 can determine a plurality of phase differences at the same time; alternatively, the first phase detector 15 can determine the plurality of phase difference sequentially. In this embodiment, the first phase detector 15 provides signals corresponding to the phase differences to the lock-in amplifier 22 after determining the phase differences. The lock-in amplifier 22 is configured to filter the noise and to amplify or enhance the signal components corresponding to the phase information.

As mentioned previously, the light splitter 16 is configured to provide a part of the comb laser to the fourth optical path P4. On the fourth optical path P4, the comb laser is provided to the first phase detector 15 to a server as said reference light after being filtered by the third band-pass filter 24. The center frequency of the third band-pass filter 24 is related to the first pulse repetition rate. That is, the third band-pass filter 24 is configured to block the other frequency components except for the frequency components of the comb laser.

Similarly, on the third optical path P3, the second phase detector 20 is configured to determine a plurality of phase difference between a reference frequency and the to-be-examined laser beams. Said reference frequency is, for example, said second pulse repetition rate fm. The details similar to the previous description is not repeated herein.

Therefore, the optical phase difference detection system can obtain phase difference information corresponding to the first pulse repetition rate fr or the second pulse repetition rate fm via selectively adjusting the comb laser as well as via the second optical path P2 and the third optical path P3. Because the first pulse repetition rate fr is different from the second pulse repetition rate fm, the phase obtained by the first phase detector 15 and the phase obtained by the second phase detector 20 can be transformed into corresponding distances according to the first pulse repetition rate fr and the second pulse repetition rate fm respectively. Thus, by appropriately setting the first pulse repetition rate fr and the second pulse repetition rate fm and by modulating the comb laser to have the first pulse repetition rate fr or to have the second pulse repetition rate fm, phase information corresponding to distance in different scales can be obtained via the optical phase difference detection system provided in this invention, wherein the second pulse repetition rate fm can be utilized for eliminating uncertainty of distance detection and the first pulse repetition rate can be utilized to achieve accurate distance detection. Furthermore, the first phase differences obtained by the first phase detector 15 and the second phase differences obtained by the second phase detector 20 can be utilized for obtaining one or more distances between said reference point and the device under test 2. That is, devices at the back end of the system can obtain distances between the reference point and a plurality of points on the device under test 2 respectively according to the first phase differences or the second phase differences; alternatively, the devices at the back end can obtain a distance between a certain point on the device under test 2 and the reference point according to the first phase differences or the second phase differences. The way to obtain the distance is not limited to the above description.

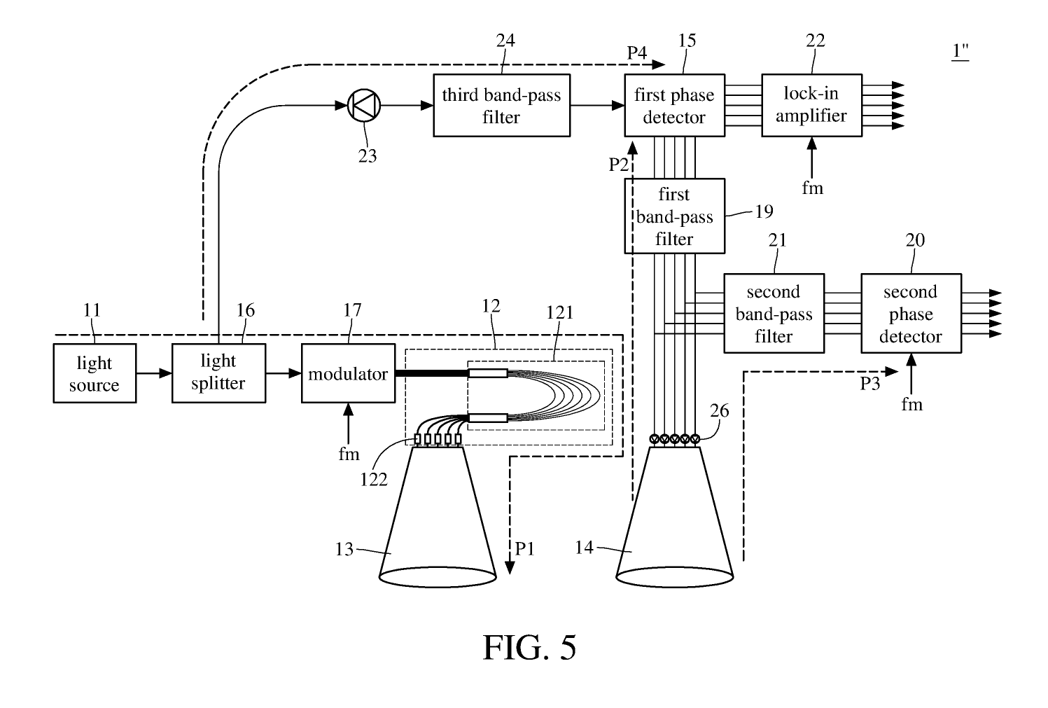

Please refer to FIG. 5. FIG. 5 is a system structure diagram of an optical phase detection system in another embodiment of this invention. In the embodiment shown in FIG. 5, the structure of the optical phase difference detection system 1″ is basically similar to the structure of the optical phase difference detection system 1′ and the similar contents are not repeated. The difference between the optical phase difference detection system 1″ and the optical phase difference detection system 1′ is that the optical phase difference detection system 1″ has two optical interfaces, wherein said two optical interfaces are served as the transmitter 13 and the receiver 14 respectively. Because the transmitter 13 and the receiver 14 are implemented respectively, there is no optical circulator 18 and second frequency dividing device 25 in the optical phase difference detection system 1″.

In view of the above, this invention provides an optical ranging method, an optical phase difference detection system and a ranging light source thereof. By generating a plurality of emitting laser beams according to the comb laser, said method, system and source can provide a plurality of laser beams corresponding to different wavelengths or different frequencies without high speed active electronic components, and thus the components or devices at the back end of the system can obtain distances according to information corresponding to the laser beams. As a result, the accuracy of the measurement can be raised in avoidance of high costs.

Although the aforementioned embodiments of this disclosure have been described above, this disclosure is not limited thereto. The amendment and the retouch, which do not depart from the spirit and scope of this disclosure, should fall within the scope of protection of this disclosure. For the scope of protection defined by this disclosure, please refer to the attached claims.

### SYMBOLIC EXPLANATION

1 [symbol] 1′ [symbol] 1″ optical phase difference detection system
11 light source
12 first frequency dividing device
121 frequency divider
122 collector
123 [symbol] 124 waveguide grating
13 transmitter
14 receiver
15 first phase detector
16 optical splitter
17 modulator
18 optical circulator
19 first band-pass filter
2 device under test
20 second phase detector
21 second band-pass filter
22 lock-in amplifier
23 diffusion component
24 third band-pass filter
25 second frequency dividing device
251 second frequency divider
252 collector
253 [symbol] 254 waveguide grating
26 diffusion component
P1 first optical path
P2 second optical path
P3 third optical path
P4 fourth optical path
TRX optical interface
SCL optical spectrum
SL1 [symbol] SL2 [symbol] SL3 sub-band
20 second phase detector
21 second band-pass filter
22 lock-in amplifier
23 diffusion component
24 third band pass filter
25 second frequency dividing device
251 second frequency divider
252 collector
253 [symbol] 254 waveguide grating
26 diffusion component
P1 first optical path
P2 second optical path
P3 third optical path
P4 fourth optical path

### CHARACTERISTIC CHEMICAL FORMULA

None

1. An optical ranging method, comprising:
generating a comb laser;
generating a plurality of emitting laser beams according to the comb laser, wherein the emitting laser beams are corresponding to different central frequencies respectively;
outputting the emitting laser beams to different locations of a device under test to generate a plurality of reflected laser beams;
generating a plurality of to-be-examined laser beams according to the reflected laser beams, wherein the central frequencies of the to-be-examined laser beams are different from each other;
determining a plurality of first phase differences, wherein one of the first phase differences is a difference between a reference light and a respective one of the to-be-examined laser beams; and
determining a distance between a reference point and the device under test according to the first phase differences.

2. The optical ranging method according to claim 1, wherein generating the plurality of emitting laser beams according to the comb laser comprises:
inputting the comb laser into a frequency divider to generate a plurality of divided laser beams, wherein the divided laser beams are corresponding to different central frequencies respectively; and
collecting the divided laser beams to form the emitting laser beams respectively.

3. The optical ranging method according to claim 2, wherein collecting the divided laser beams to respectively form the emitting laser beams comprises:
collecting the divided laser beams according to difference collection bands respectively to form the emitting laser beams, wherein the collection bands are corresponding to different center frequencies respectively.

4. The optical ranging method according to claim 2, wherein the comb laser has a first pulse repetition rate, and generating the plurality of emitting laser beams according to the comb laser comprises selectively modulating the comb laser to have a second pulse repetition rate, wherein the second pulse repetition rate is not higher than the first pulse repetition rate.

5. A ranging light source, comprising:
a light source configured to generate a comb laser;
a modulator configured to modulate the comb laser;
a frequency dividing device configured to generate a plurality of emitting laser beams according to a modulated or unmodulated comb laser outputted by the modulator, wherein the emitting laser beams have different center frequencies respectively; and
a transmitter configured to output the emitting laser beams;
wherein the light source, the frequency dividing device and the transmitter are disposed on a first optical path, and the frequency dividing device is between the light source and the transmitter on the first optical path.

6. The ranging light source according to claim 5, wherein the frequency dividing device comprises:
a frequency divider configured to generate a plurality of divided laser beams according to the comb laser, wherein the divided laser beams have different central frequencies respectively; and
a plurality of collectors configured to collect the divided laser beams to form the emitting laser beams respectively;
wherein the frequency divider is between the collectors and the modulator on the first optical path.

7. The ranging light source according to claim 6, wherein the collector collects the divided laser beams according to the collection bands, wherein the collection bands have different central frequencies respectively.

8. The ranging light source according to claim 6, wherein the frequency divider is an arrayed waveguide grating.

9. The ranging light source according to claim 5, wherein the comb laser has a first pulse repetition rate, and the modulator is configured to selectively modulate the comb laser to have a second pulse repetition rate and to provide the modulated or unmodulated comb laser to the frequency dividing device;
wherein the second pulse repetition rate is not higher than the first pulse repetition rate.

10. An optical phase difference detection system, comprises:
a light source configured to generate a comb laser;
a modulator configured to modulate the comb laser;
a first frequency dividing device configured to generate a plurality of emitting laser beams according to a modulated or unmodulated comb laser outputted by the modulator, wherein the emitting laser beams have different central frequencies respectively;
a transmitter configured to output the emitting laser beam to different locations of a device under test to form a plurality of reflected laser beams;
a receiver configured to receive the reflected laser beams; and
a first phase detector configured to determine a plurality of first phase differences, wherein one of the first phase differences is a difference between a reference light and a respective one of a plurality of to-be-examined laser beams formed according to the reflected laser beams;
wherein the light source, the frequency dividing device and the transmitter are disposed on the first optical path while the receiver and the first phase detector are on a second optical path, with the frequency dividing device disposed between the light source and the transmitter on the first optical path.

11. The optical phase difference detection system according to claim 10, wherein the first frequency dividing device comprises:
a frequency divider configured to generate a plurality of divided laser beams according to the modulated comb laser, wherein the divided laser beams have different central frequencies respectively; and
a plurality of collectors configured to collect the divided laser beams to form the emitting laser beams respectively;
wherein the frequency divider is between the collectors and the modulator on the first optical path.

12. The optical phase difference detection system according to claim 11, wherein the collectors collect the divided laser beams according to different collection bands, wherein the collection bands are corresponding to different central frequencies respectively.

13. The optical phase difference detection system according to claim 11, wherein the frequency divider is an arrayed waveguide grating.

14. The optical phase difference detection system according to claim 10, wherein the comb laser has a first pulse repetition and the modulator is configured to selectively modulate the comb laser to have a second pulse repetition rate;
wherein the second pulse repetition rate is not higher than the first pulse repetition rate.

15. The optical phase difference detection system according to claim 10, further comprising a lock-in amplifier configured to provide an output signal according to the detection result of the first phase detector.

16. The optical phase difference detection system according to claim 10, further comprising an optical splitter disposed between the light source and the modulator on the first optical path, with the optical splitter configured to provide the comb laser to the first phase detector to serve as the reference light.

17. The optical phase difference detection system according to claim 10, wherein the first frequency dividing device is further located between the receiver and the first phase detector on the second optical path, with the first frequency dividing device configured to generate a gathered laser according to the reflected laser beams, wherein the optical phase difference detection system further comprises:
an optical circulator configured to provide the comb laser to the first frequency dividing device along a first circulating optical path inside the optical circulator and configured to provide the gathered laser to a second frequency dividing device along a second circulating optical path inside the optical circulator; and
said second frequency dividing device disposed between the optical circulator and the first phase detector, with the second frequency dividing device configured to generate the to-be-examined laser beams according to the gathered laser;
wherein the first circulating optical path and the second circulating optical path are not overlapped, and the transmitter, the first frequency dividing device, the optical circulator, the second frequency dividing device and the first phase detector are located on the second optical path, with the first frequency dividing device between the optical circulator and the transmitter, and with the second frequency dividing device between the optical circulator and the first phase detector.

18. The optical phase difference detection system according to claim 17, further comprising a second phase detector, with the second phase detector configured to determine a plurality of second phase difference, wherein one of the second phase difference is a difference between a reference frequency and a respective one of the to-be-examined laser beams.

19. The optical phase difference detection system according to claim 18, further comprising a first band-pass filter and a second band-pass filter, with the first band-pass filter disposed between the second frequency dividing device and the first phase detector on the second optical path, with the second frequency dividing device, with the second band-pass filter and the second phase detector disposed on a third optical path, and with the second band-pass filter between the second frequency dividing device and the second phase detector;
wherein the center frequency of the first band-pass filter corresponds to a first pulse repetition rate, the center frequency of the second band-pass filter corresponds to a second pulse repetition rate, and the second pulse repetition rate is not higher than the first pulse repetition rate.

20. The optical phase difference detection system according to claim 10, wherein the receiver provides the reflected laser beams to the first phase detector as the to-be-examined laser beams.

21. The optical phase difference detection system according to claim 20, further comprising a second phase detector, with the second phase detector configured to determine a plurality of second phase difference, wherein one of the second phase difference is a difference between a reference frequency and a respective one of the to-be-examined laser beams.

22. The optical phase difference detection system according to claim 21, further comprising a first band-pass filter and a second band-pass filter, with the first band-pass filter disposed between the second frequency dividing device and the first phase detector on the second optical path, with the second frequency dividing device, the second band-pass filter and the second phase detector disposed on a third optical path, and with the second band-pass filter between the second frequency dividing device and the second phase detector;
wherein the center frequency of the first band-pass filter corresponds to a first pulse repetition rate, the center frequency of the second band-pass filter corresponds to a second pulse repetition rate, and the second pulse repetition rate is not higher than the first pulse repetition rate.
